(19) United States
(12) Patent Application Publication
(10) Pub. No.: US 2014/0019148 A1
(43) Pub. Date: Jan. 16, 2014

(54) CHANGE PROCESS FOR CONSTRUCTION PROJECTS

(71) Applicant: Leonard Buzz, Spring, TX (US)

(72) Inventor: Leonard Buzz, Spring, TX (US)

(73) Assignee: On Center Software, Inc., The Woodlands, TX (US)

(21) Appl. No.: 13/546,813

(22) Filed: Jul. 11, 2012

(51) Int. Cl. G06Q 10/00

(52) U.S. Cl. 705/1.1

(57) ABSTRACT

A method for keeping track of and automatically determining the quantity and/or conflicts associated with change orders in a construction project is disclosed. Once a bid is accepted, each new change order can be turned into a new change order bid in which objects and/or building conditions are added, changed or deleted as desired. The method automatically calculates the building condition quantity changes between the original base bid and each change order. Additionally, the method links objects in each of the change order bids to each other and to the base bids such that pending changes in one change order are visible in a different change order bid. This allows construction professionals to automatically determine the building condition quantity differences for a new change order, keep track of various change orders and their status, and quickly determine conflicts between various change orders.

### TECHNICAL FIELD

The present invention relates to management of construction projects, and in particular to techniques for processing change orders in a construction project.

### BACKGROUND

Construction professionals generally use computer software programs to more efficiently provide pricing for large construction projects. Some of these construction software programs include capabilities for drawing or uploading construction plans and engineering drawings. The software programs also allow a user to enter a list of building conditions that are required to be completed for a given construction project. The term building condition refers to each separate component of the construction project that needs to be built or installed, for example, a ceiling, an exterior structure, doors, or a particular type of wall are all considered building conditions. In order to price a project correctly, an efficient method of calculating and tracking the quantities associated with each building condition may be needed. One way of achieving that is by creating live objects on the construction drawings for each building condition. As building conditions are entered, a user can create live objects on the construction drawings, where the live objects are linked to and represent particular building conditions. The resulting file quantifies the building conditions and as a result can be used either by itself or in combination with other software programs to calculate a projected cost for the entire project. This enables the construction professional using such a program to efficiently prepare a bid for the construction project.

Once a bid is accepted and the construction project begins, the same software program can be used to assist construction professionals in monitoring and managing the project. Often during the progress of a construction project, changes need to be made either to the original drawings or to specific building conditions. For example, the type of interior door used may need to be changed, or the size of a room may need to change, changing with it the dimensions of the walls and flooring associated with the room. These changes may be requested by the owner or the architect or may be determined necessary by the builder. At any given time, there may be multiple changes requested by multiple parties.

A change in one aspect of the project can affect other building conditions in the project and most likely results in a change in the total cost. Different proposed changes can also be in conflict with each other. Thus, it is important to be able to determine what affect a proposed change will have on the overall project. It is also crucial to keep track of pending changes to make sure that they are not forgotten and they are considered when a future change request is received and processed. Currently, construction professionals have to create a separate project file for each proposed change to determine the effects of that change. As a result, the construction professionals have to remember each proposed change and make sure that each proposed change is considered when another change order is received. This method is burdensome, time consuming, and highly prone to error.

Thus, it would be desirable to implement an efficient method for keeping track of change order on a quantity, location and status basis for a construction project.

### SUMMARY

A method for keeping track of and automatically determining the quantities associated with building conditions in change orders in a construction project. Once a bid is accepted, each new change order can be turned into a new change order bid in which objects and/or building conditions are changed as desired. The method automatically calculates the quantities of building conditions associated with each change order. Additionally, the method links objects and drawings in each subsequent change order bid to previous change orders and to the base bids. Creating a new change order bid will display a complete view of the original bid with all the counted building conditions displaying a total quantity of zero. All the objects from the original bid are displayed in the same color. When changes are made to an object in a change order, the object is displayed in a different color. If a second change order is then created, the second change order displays the objects that were changed in the first change order in one color, unchanged objects in another color, and objects that are changed in the second change order in a color that is different from the first two colors. This allows construction professionals to automatically determine the quantities of building conditions associated with a new change order, keep track of various change orders and their status, and quickly determine if there is a conflict between various change orders.

### BRIEF DESCRIPTIONS OF THE DRAWINGS

FIG. 1 is a diagram illustrating an exemplary user interface screen for a construction software program showing a construction drawing and its related information.

FIG. 2 is a diagram illustrating an exemplary user interface screen for a construction software program showing properties for a building condition in the construction drawing.

FIG. 3 is a diagram illustrating an exemplary user interface screen for the construction software program providing cost information for building conditions in the drawing.

FIG. 4 is a diagram illustrating an exemplary user interface screen having a change order menu.

FIG. 5 is a diagram illustrating an exemplary change process menu in a construction software program.

FIGS. 6A-6E are diagrams illustrating exemplary user interface screens for different change orders.

FIG. 7 is a diagram illustrating how user interface screens for different change orders are linked.

### DETAILED DESCRIPTIONS

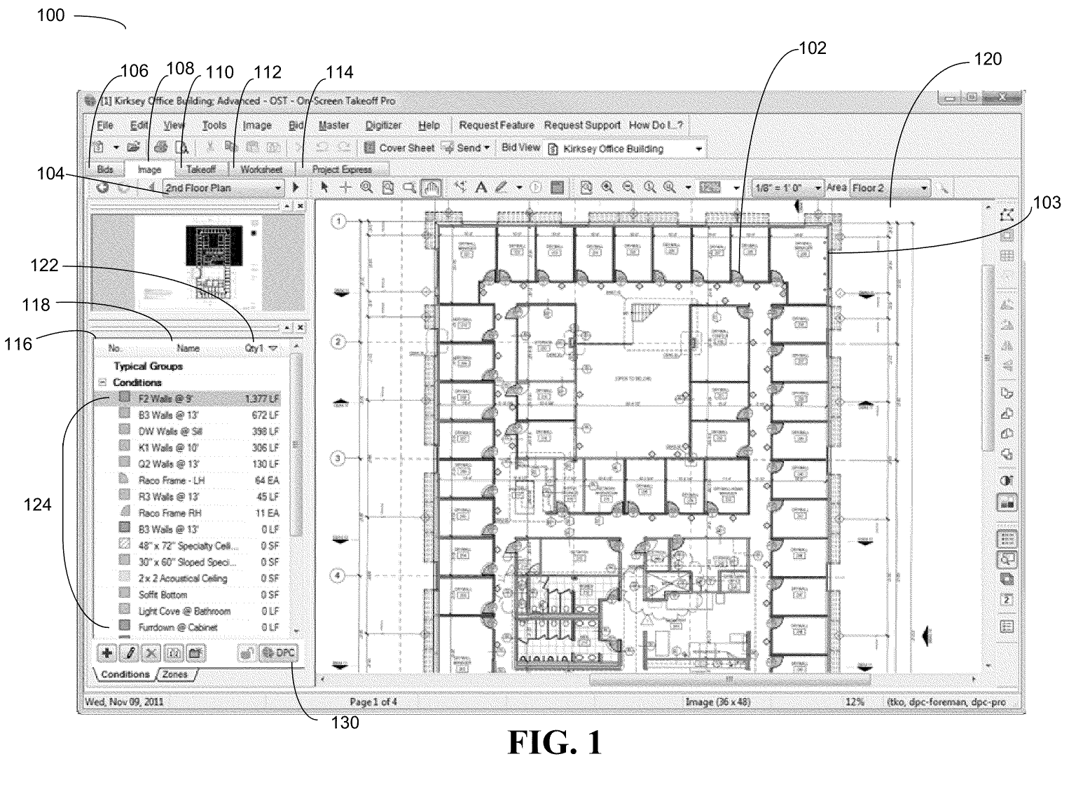

FIG. 1 illustrates an exemplary user interface screen 100 used in a construction project software. Generally, a first step in using this software program is to create or upload one or more engineering or construction drawings into the program. The construction drawings for each project generally include representations for all the various building conditions in the project.

The user interface screen 100 includes various buttons and drop down menus that provide a variety of options for different views and processing of construction related information. For example, the screen 100 includes a button 106 for choosing to view the Bids, a button 108 to view the Image, a button no for viewing quantity totals in Takeoff, a button 112 to view an estimating Worksheet, and a button 114 to view the Project Express for sending and receiving bids. As shown in FIG. 1, when selected, the Image button 108 provides a view of a construction drawing, such as the construction drawing 120. Additionally, a dropdown menu 104 allows the user to select which page or area of the construction project to view. The selected portion can be any part of the construction project for which a separate construction drawing exists. For example, the dropdown menu 104 selected in screen 100 is the 2^{nd} Floor Plan and the corresponding drawing 120 includes all the various building conditions in the 2^{nd} Floor area of this construction project. The drawing 120 by itself, however, is just a two dimensional drawing and does not include any objects that have underlying values. Objects are created on the drawing during the quantity Take Off process.

The quantity take off is a process performed by estimators in a construction project to determine an estimated cost for the project. The process involves counting or quantifying all building conditions for the project. For example, for the building condition of interior doors, all required interior doors are counted. In the construction project software of the preferred embodiment, this process can be performed by selecting a building condition from the view pane 116 and clicking on places and/or areas on the drawing 120 where the selected building condition is to be located. By doing so, an object that corresponds to the selected building condition is placed on the drawing. An object is generally represented by a colored line or shape, depending on the type of the building condition, and is linked to the building condition represented by the object. For conditions that are counted by their quantity such as doors and windows, merely clicking on a spot on the drawing creates a colored representation of that condition and adds one to the total counted quantity for that building condition. An example is the door 102 shown in the drawing 120. By selecting door (not shown) in the view pane 116 and clicking on the spot on the drawing, an object 102 is created. The object 102 is a live object meaning that it recognizes that it represents the “door” building condition on the 2^{nd} floor, and it increases the total quantity of the count for doors by one.

For objects, such as walls that are quantified by their length, a line is usually drawn on the drawing to create a corresponding object. An example is the wall 103 on the drawing 120. The software automatically counts or measures the objects on the drawings to provide a quantity for each building condition. In this manner, the quantity take off process achieves two objectives, one is quantifying the building conditions in the project, and the other is creating live objects that have underlying values and are linked to corresponding building conditions.

The two dimensional image shown in the drawing 120 can also be three dimensional (3D) such as a 3D CAD drawing, Building Information Modeling (BIM), or the like. A 3D drawing is advantageous in that the user can view each of the various building areas in a manner that is closer to the actual shape and design of the buildings and can examine each object easier. Some 3D models also include objects that have built-in associated quantities. The quantities can include the size of the object and may also include the associated labor activities and materials required to complete it. Thus, a quantity Take Off process of creating objects is not necessary in some 3D models.

Referring back to the user interface screen 100 of FIG. 1, the screen allows the user to click on each object in the drawing 120 to select the associated building condition. For example, the user can click on and select a particular type of wall, such as the “F2 Walls @ 9′” wall 103 selected in FIG. 1. When selected, that building condition becomes highlighted in the view pane 116. The view pane 116 also displays a list of names 118 of all building conditions 124 and a corresponding column Qty1 122 showing the associated total quantity for each building condition. The column Qty1 122 represents the quantity associated with each building condition in the drawing 120 in an appropriate unit of measurement.

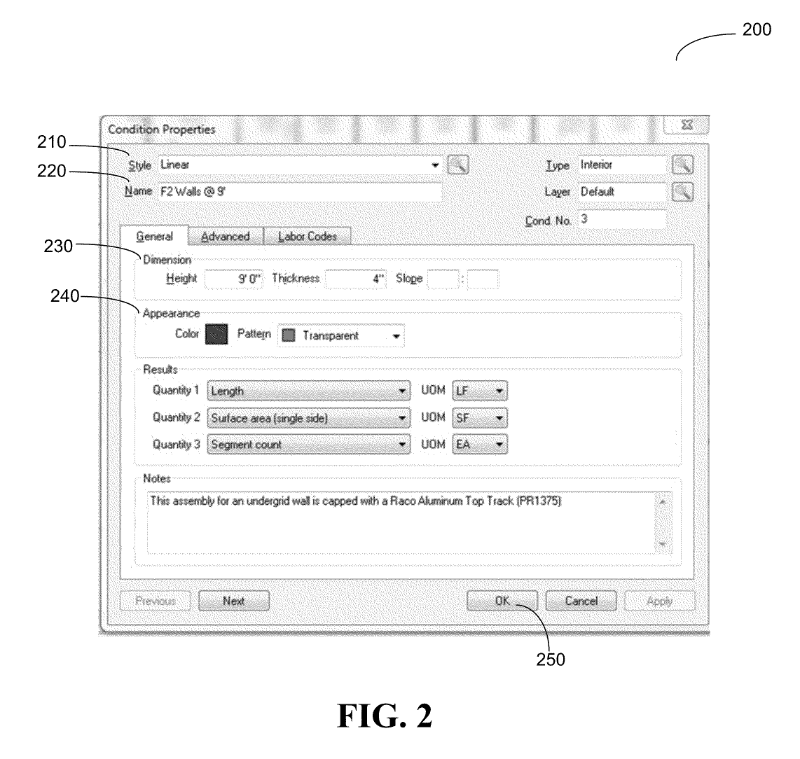

Double clicking on or otherwise selecting a building condition in the view pane 116 brings up a window for setting properties of that building condition. For example, double clicking on F2 Walls @ 9′ in the view pane 116, brings up the properties window 200 of FIG. 2. The condition properties window 200 includes entries for style 210 and name 220. The style 210 enables the user to select a type of unit of measurement for the building condition. “Linear” is used for building conditions such as walls that are measured in linear feet, “each” is used for building conditions such as doors and frames that count each quantity, and “area” is used for building conditions such as tiles that are measured in square feet. The name 220 allows the user to change or select a name for the building condition. Entries for dimension 230 allow the user to select height, thickness and slope for the building condition and entries for Appearance 240 enable the user to select a color and pattern for how the object representing the building condition will be shown on the drawing. Other options are also presented in window 200. Once changes have been made to the desired properties, the user is taken back to the user interface 100 by selecting the OK button 250.

Information about building conditions that is available in the construction project file of FIG. 1 can be used to create a cost estimate for the project. In the preferred embodiment of the present invention embodiment, this is done by using a worksheet that is integrated into the construction project software represented in FIG. 1.

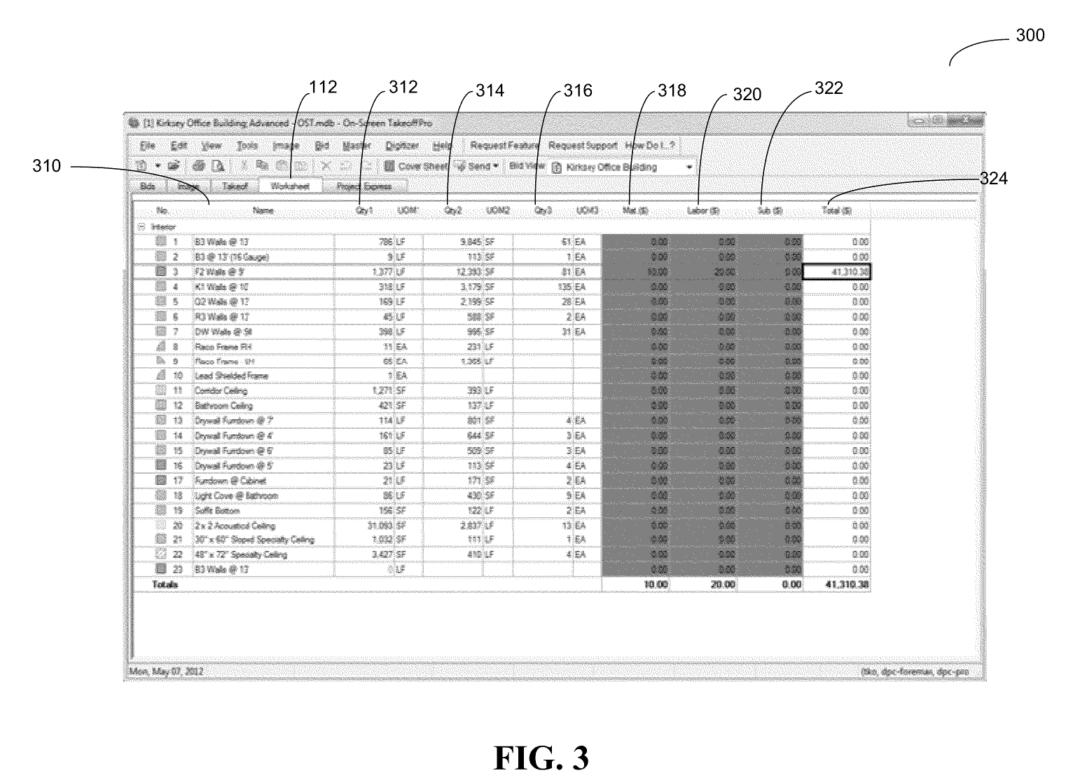

Clicking on the Worksheet button 112 of FIG. 1, takes the user to the estimating Worksheet screen 300 of FIG. 3.

The Worksheet screen 300 includes a column 310 that lists the name of the various building conditions and columns 312, 314 and 316 that list the associated quantities needed for each of the named building conditions. The screen 300 also includes a column 318 for listing the cost of material associated with each building condition, a column 320 for listing the cost of labor for each building condition, a column 322 which displays a sub total for the costs associated with each building condition and a column 324 that displays the total cost for each building condition. After quantity and cost information for building conditions in a project has been entered, the software program can calculate a total estimated cost for the construction project.

In an alternative embodiment, a separate software program designed for estimating construction projects, such as the software program Quick Bid™, provided by On Center Software™, Inc. is used to calculate the estimated costs associated with a project. When a separate estimating program is used, a file is created in the estimating program containing detailed cost information for each building condition in the construction project file presented in FIG. 1. This estimating file is linked to the file represented in the interface screen 100.

After a bid has been accepted and the construction project begins, often changes need to be made either to the original drawings or to specific building conditions. These changes may be deemed necessary by the construction professional, or may be requested by the owner or the architect. Often owners ask the construction professional to find out the costs of making a change before they approve the change. Some changes are minor, such as changing the color of the paint, and some are substantial such as changing the dimensions of a room which could affect the dimensions of all adjacent rooms. In either case, when a change is requested, the construction professional needs to determine how the change affects the overall cost of the project. To do so, depending on the type of change, the construction professional changes the building condition related to the change and/or the building condition's associated objects in the drawing 120. The software will then accordingly change the quantity and, in some instances, the total cost of the building condition and the resulting total cost would reflect that change. The construction professional can then notify the owner of the cost difference resulting from the change such that the owner can approve or reject the change.

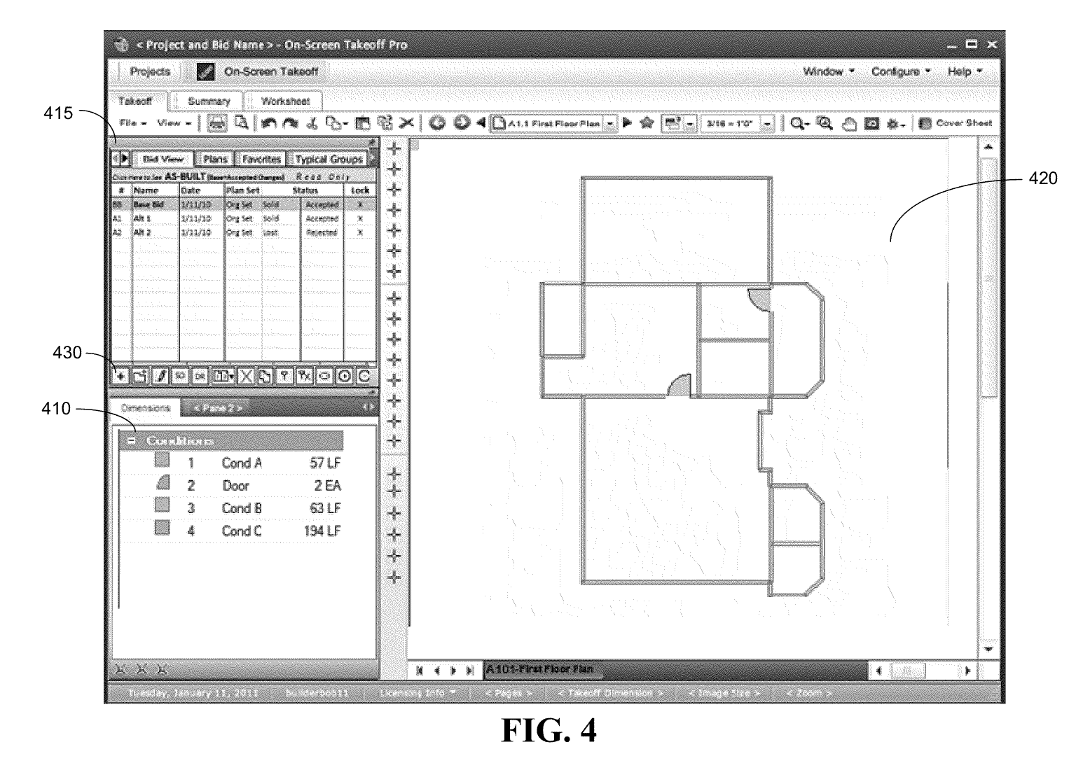

During the time a change order is pending, i.e., while it is pending approval by the owner, the construction professional cannot make any changes to that pending change order. However, the construction professional would still need to keep track of the change order and ensure that it is not forgotten. To do so, in prior art software programs, the construction professional would need to save a different copy of the building file which included the change and keep track of all the various copies of that file. If other change orders come in when a prior one is still pending, the construction professional would have to keep track of both requests. In addition, the construction professional would need to determine if there is a conflict between the two change orders and whether the pricing of the second change order is different when taking into account the first change order. Previously, all of these functions had to be done manually. The preferred embodiment of the present invention automates this process and visually presents the differences on the screen. This is illustrated in the screen 400 of FIG. 4.

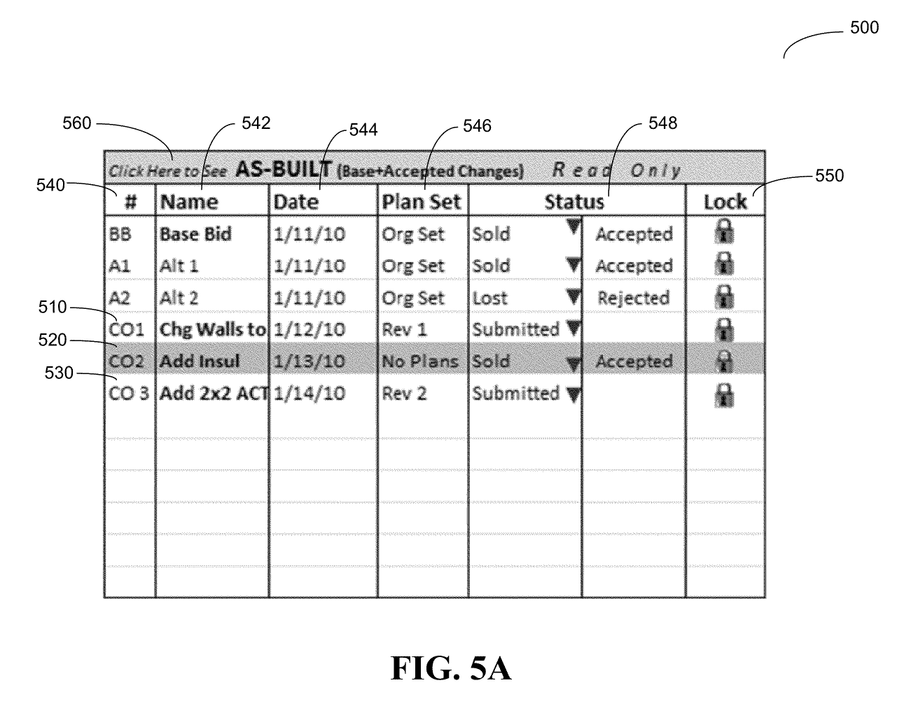

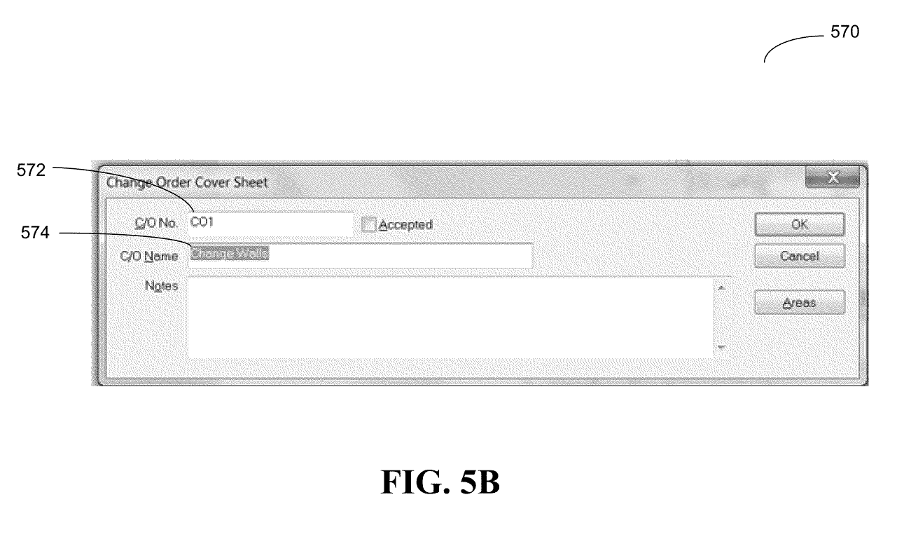

Screen 400 includes a construction drawing 420, a conditions view pane 410 and a change order view pane 415. Construction drawing 420 shows the construction drawing corresponding to the selected image. The conditions view pane 410 shows the list of building conditions in the drawing 420 along with quantities for those conditions. Change order view pane 415 includes a list of the various versions of the bid along with a corresponding status for each bid. An exemplary change order view pane is illustrated in detail in FIG. 5A.

The table 500 shown in FIG. 5A includes a list of various versions of the bid, as the bid goes through changes. The list generally starts with a Base Bid, which is the original bid created and submitted to the owner. There may be alternative versions of the base bid, if for example, the estimator presented the owner with alternative options for building the project with different total costs. As can be seen, table 500 includes two alternative versions, Alt 1 and Alt 2. After the base bid has been submitted and accepted, other versions of the bid are created when new change orders are submitted. For example, entry 510 in table 500 is for a change order that changes the walls, entry 520 is for adding insulation, and entry 530 is for adding a 2×2 ACT, i.e., acoustical tile ceilings.

Table 500 includes a column 540 for a version number assigned to each particular version of the bid and a column 542 for the name that is given to each version. The name is selected by the user generating the change order and is usually selected such that it is descriptive of the changes being made. The date column 544 lists the date each version of the bid was created. The plan set column 546 indicates which set of the drawings the version is linked to and a status column 548 shows the status of each change order or bid. For the base bid, the status column indicates whether the bid was accepted or rejected. For change orders, the status column indicates whether they were accepted, rejected or are still pending. A lock column 550 illustrates whether a version has been locked. A bid or change order is locked when that version of the bid is submitted for approval. Clicking on the top portion 560 of table 500 takes the user to an As-Built version of the bid that shows a screen showing the building conditions and quantities of the base bid and all approved changes.

In this manner, table 500 shows the user, at a glance, what changes have been requested and the status of those changes. Thus, the construction professional does not have to keep separate files for each change order bid and does not have to remember each separate change order. If the construction professional has a question on the status of a change order, all he has to do is take a look at the view pane 415 to determine the status. Thus, the change order view pane 415 of FIG. 4 increases efficiency and accuracy in processing change orders for a construction project.

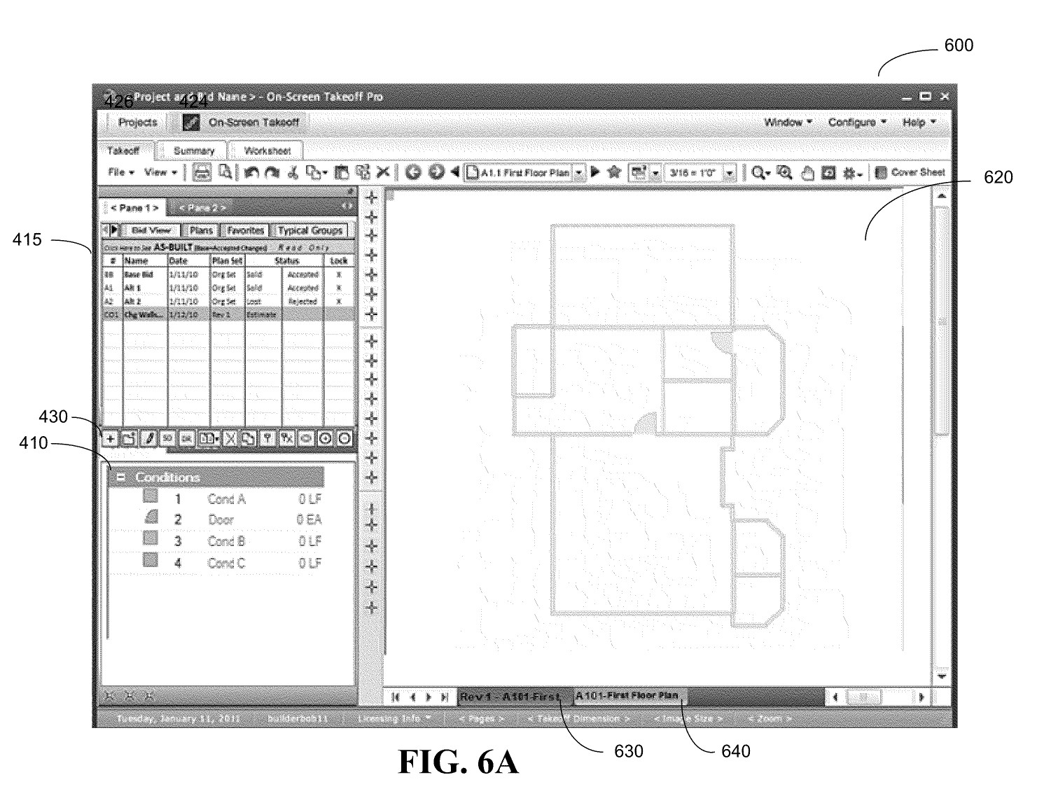

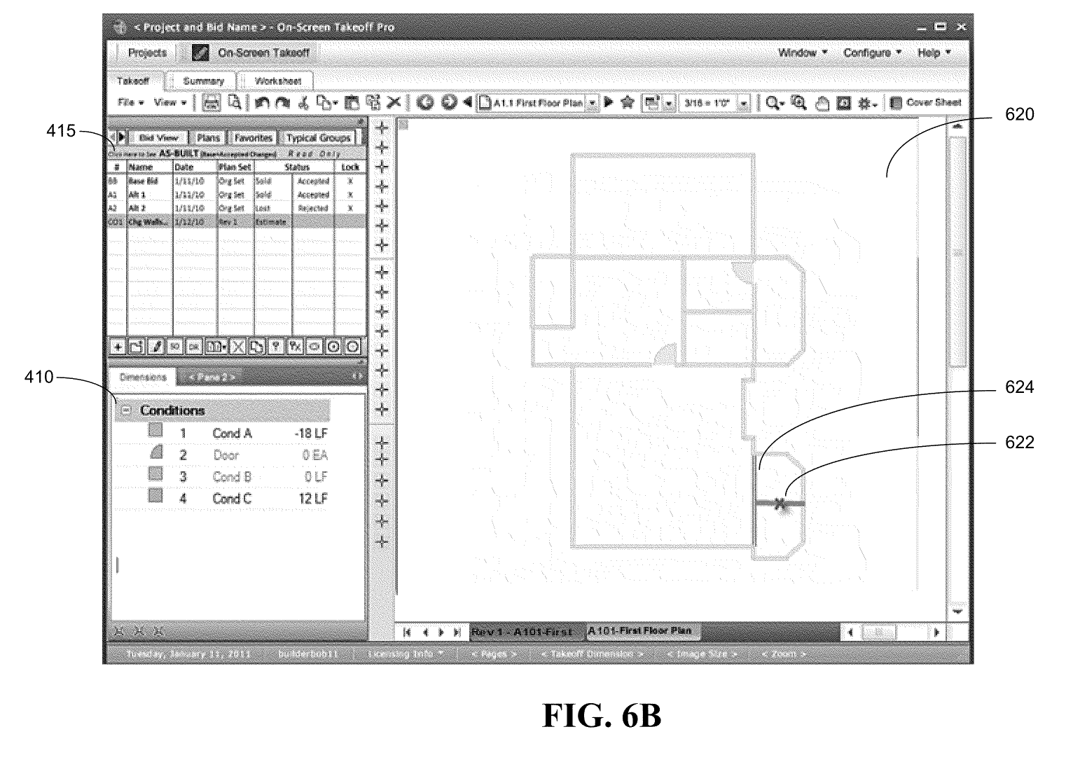

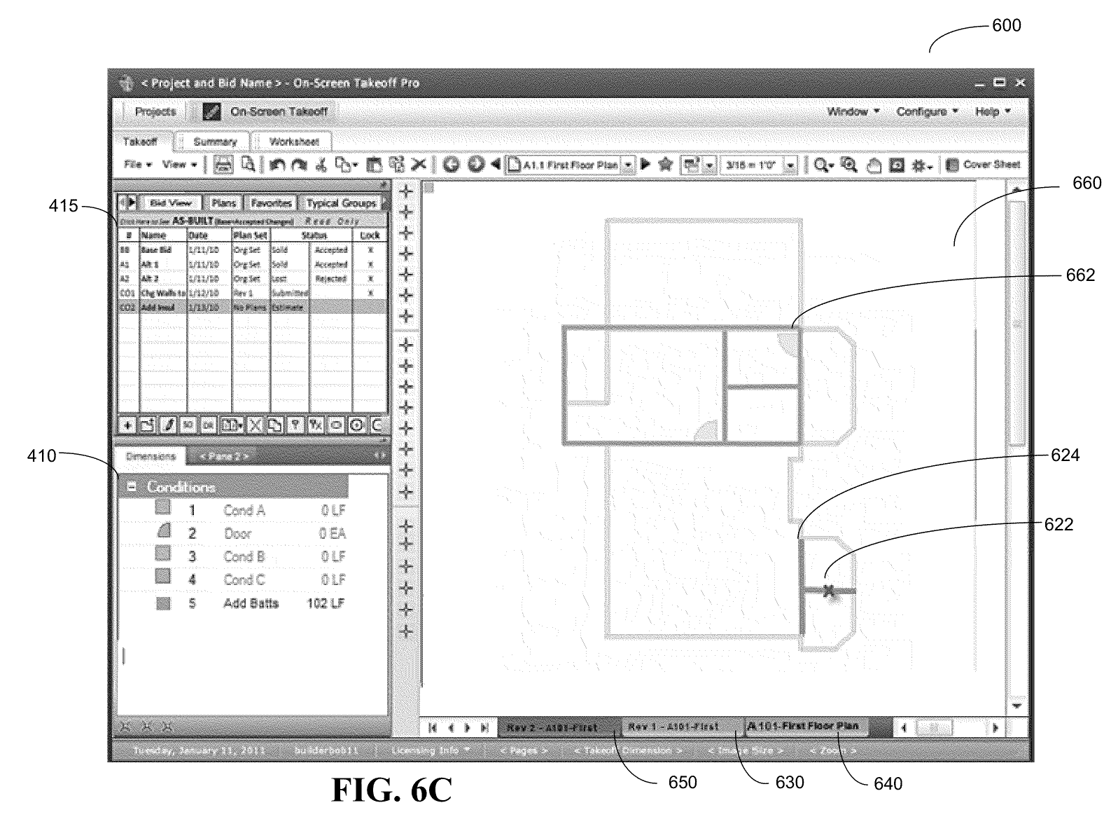

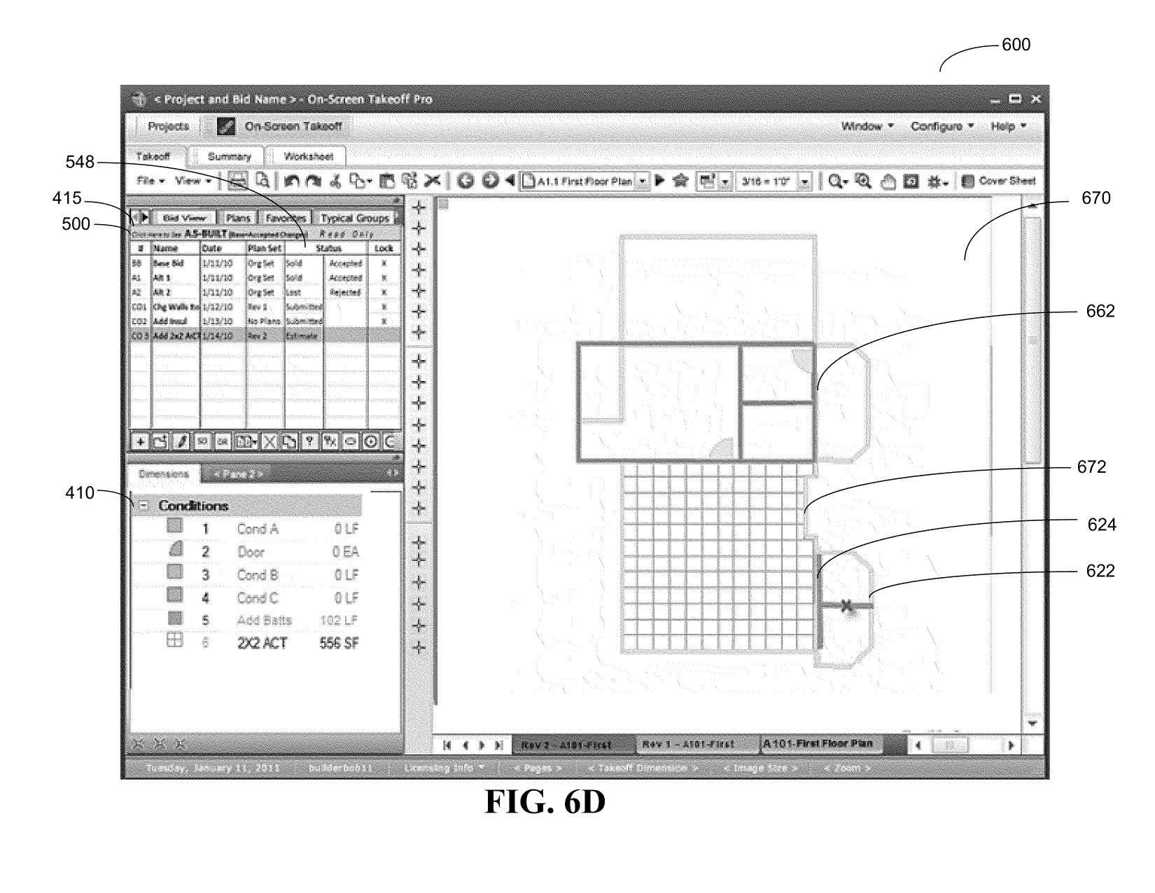

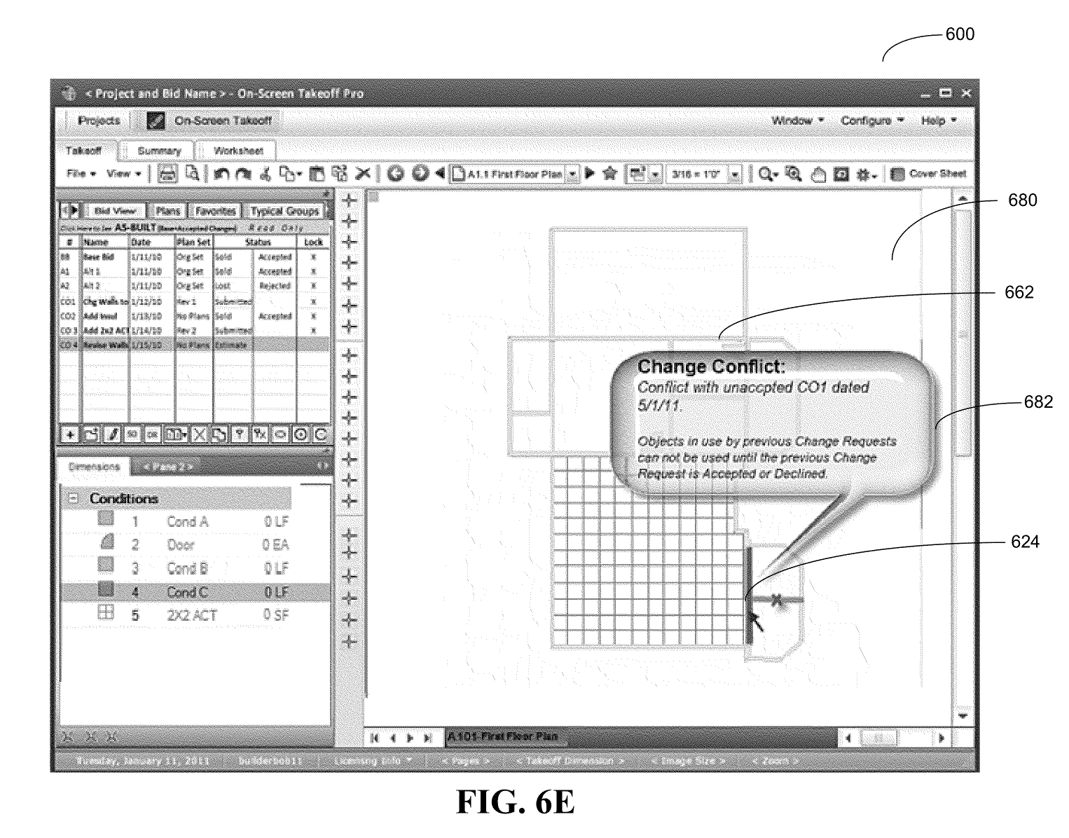

A change order is created by clicking on the plus button 430 (shown in FIG. 4) in the change order view pane 415. For example, to create the change order for Chg Walls 510, the user would click on the plus button 430 in the view pane 415 and will be taken to a change order cover sheet such as the one illustrated in FIG. 5B. The change order cover sheet 570 includes an input box 572 for entering a version number for the change order bid and a name input box 574 for entering a name for the new change order. After a name and a version number has been entered, the user can click on the OK button to create the new change order and be taken to the screen 600 of FIG. 6A to view the new change order.

The first change order in a construction project is created by making a copy of the drawing 420 (from the base bid) to generate a drawing 620. The drawing 620 is identical to the drawing 420 with the exception that all the objects in the drawing are shown in the same color, for example, grayed. Further, in the condition view pane 410 displayed with the drawing 620, the quantities for all the building conditions associated with the drawing 620 are displayed as zero. The status for the new change order in the change order view pane 415 is automatically set to Estimate. On the bottom of the screen 600, an additional tab 630 is created for the drawing 620. The user can switch to the original drawing 420 by clicking on the tab 640 and switch back to the drawing 620 by clicking on the tab 63. The user can also switch to the drawing corresponding to each version of the bid by clicking on the corresponding row in the view pane 415. Thus, the program prepares a change order version of the base bid by copying the original bid, graying out the objects on the drawing, and displaying the quantities associated with the building conditions as zero.

As illustrated in FIG. 6B, changes in a change order version of the bid are generally made directly on the drawing 620. A change is made, for example, by clicking on an object in the drawing 620 and deleting or resizing it. Objects are added by clicking on a condition in the condition view pane 415 and then depending on the type of condition selected, either merely clicking on a spot on the drawing 620 or clicking on a spot and dragging the mouse to create a desired length and/or area for the new object.

When a change is made to an object on the drawing 620, the color of the object automatically changes. Thus, while all the unchanged objects remain the same color, any object that is changed is displayed in a different color to clearly show what changes are being made to the project. In one embodiment, all changes associated with one building condition are all displayed in one color. In another embodiment, each change to an object is displayed in a different color. Other configurations are also possible. In the preferred embodiment of the present invention, deleted objects are marked with an X to clearly show that they have been deleted. In another embodiment, deletions are displayed in a particular color, while all increases in size are displayed in another color, and all decreases in size in yet another color. Various other embodiments and color variations are possible.

A change made to an object on the drawing also automatically changes the quantity of the building condition associated with that object to reflect the change made to the object. For example, when object 622 in the drawing 620, which is associated with the building condition “Cond A” is deleted, the quantity for “Cond A” is automatically changed to −18 LF (linear feet). This shows that there is a total decrease in size of 18 linear feet for “Cond A” from its' original quantity in the base bid. When an object is added, the quantity of its associated building condition is increased. As shown in FIG. 6B, object 624, which is associated with the building condition “Cond C”, adds 12 linear feet to the total quantity for “Cond C” and the change is displayed in the view pane 410. The changes made to the quantity of each building condition are calculated automatically based on the changes made on the drawings. Thus, the user does not have to make any calculations by hand, or otherwise determine how a change in the drawing affects the total quantity of a building condition.

Often during the construction phase of the project, after a first change order is requested and before it is approved, another change order request is made. When that happens, the user can click on the plus button 430 of the view pane 415 to create another change order. The new change order is illustrated in FIG. 6C. This time, a copy is made of the drawing in the latest change order bid, in this case drawing 620, to create a drawing 660. Drawing 620 includes all of the objects in the base bid and all other objects from any pending change orders. Drawing 620 has all of the objects in the drawing displayed in one color except for any object that was changed in a previously pending change order. Thus, objects 622 and 624 that were changed in the first change order appear in color in the drawing 660. In this manner, right after creating a new change order bid, the user is able to see the other pending change orders on the drawing. This decreases the potential for duplicates and conflicts between subsequent change orders and previous ones that are still pending. The quantities for all the building conditions in the view pane 410 are again displayed as zero (until a change is made in the drawing 660 that changes the numbers) and a new tab 650 is created in the bottom of the screen 600 to allow for easy switching between the various versions of the bid.

After creating the new change order CO2, the program is ready to receive changes to the drawings and/or building conditions. For change order CO2, the changes involve adding a new building condition, Add Batts. To do so, first the new building condition needs to be generated. This is done as discussed before, and involves defining characteristics of the building condition by inputting information into the condition properties screen, as illustrated in FIG. 2.

Once the new building condition, Add Batts, has been added, and it appears in view pane 410, a corresponding object can be created on the drawing 660. The object is created by selecting the building condition, Add Batts and clicking on the drawing 660 to draw the object as desired. As before, once the object is drawn on the drawing, the program automatically calculates the quantities associated with the object for the building condition based on a dimensional scale of the object drawn on the drawing. As can be seen, for Add Batts, the calculated quantity is 102 linear feet. Although the new building condition appears in view pane 410 of change order CO2, and will appear in any change orders that are created after CO2, the new building condition will not be displayed in the base bid or any prior change orders until change order CO2 is approved and accepted.

FIG. 6D illustrates another example of creating a new change order. As shown in the status column 548 of table 500, the new change order CO3 is created while the previous two change orders CO1 and CO2 are still pending. Change order CO3 involves adding a building condition named 2×2 ACT. This new building condition and its' associated object 672 are created in the same way as the building condition, Add Batts in change order CO2. Drawing 670 displays pending change order objects 622, 624 and 662 from both previous change orders. In one embodiment, the pending change order objects are displayed in the new change order in one color which is different from both the color of unchanged objects and from the color of objects changed in this change order. For example, change order objects from previous change orders are displayed in blue, unchanged objects are shown in gray, and the objects changed in this change order are shown in orange. Other color variations and/or shapes are also possible. By displaying objects that have different change statuses in different colors, the program allows the user to quickly and easily distinguish between previously submitted change order objects and new ones. This enables users to quickly recognize conflicts.

After a change order request is approved by the owner, the user can flag the respective change order in the view pane 415 as such. This is done by selecting the respective entry for the change order in the view pane 415 and changing the status to Sold and/or Accepted. Once the status is modified to accepted, changes made in that change order are applied to and displayed in the As built version of the base bid. In the remaining pending change orders, the accepted objects are displayed in the same color as that of unchanged objects. For example, if the first change order CO1 were to be marked as accepted (not shown), object 622 would be deleted in all new or pending change orders and object 624 would be displayed in the same color as the rest of the unchanged objects. When the second change order CO2 is marked as accepted, as illustrated in FIG. 6E, object 662 is displayed in the same color as the rest of the unchanged objects.

FIG. 6E also illustrates a new change order, CO4, involving an attempt to modify object 624. Object 624 was changed in change order CO1 which has not yet been accepted. When the user attempts to make a change to an object that was modified in a previously pending change order, the program automatically issues a warning, such as the warning 682 illustrated in FIG. 6E. The warning notifies the user that there is a conflict with another pending change order and informs the user which change order is the subject of the conflict. Thus, even if the user does not realize that an object is involved in another pending change order by the different color, an attempt to try to change the object would result in a warning clearly notifying the user that there is a conflict. This system notifies construction professionals of conflicts early on, increasing efficiency and preventing possible disputes with the owner or architect.

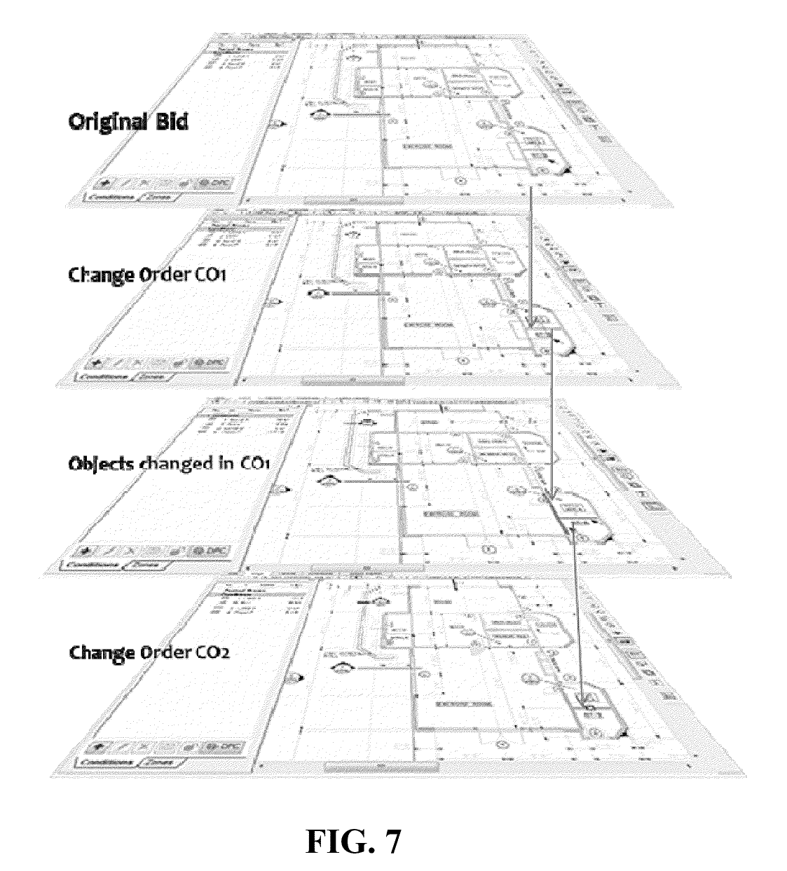

This system of keeping track of all pending change orders in one screen allows the construction professional to easily and efficiently determine the status of pending change orders and determine the relationship between various change orders. FIG. 7 illustrates how the drawings in each change order are linked which each other and with the base bid. As illustrated, the change process system of the preferred embodiment of the present invention links objects from the original bid to subsequent change orders as they are created. Creating Change Order #1 displays a complete view of the original bid with all the counted building conditions displaying a total quantity of zero. All the objects from the original bid are displayed in the same color. When changes are made in the first change order CO1, they are displayed in a different color. Those same changes are also displayed in a color that is different than the color of unchanged objects in the next created change order CO2.

Although building conditions in each change order bid show a total quantity of zero, their original quantity values are known by the program on an object by object basis. As the user selects, changes, adds or deletes building conditions and/or objects, the change process method calculates and displays the quantity difference for each building condition between the original estimate and the change orders. Creating additional change orders repeats the process and shows objects that exist in previously pending change orders in a different color for easy identification. Thus, objects are tracked across different views in different bids.

Accordingly, this construction software program allows construction professionals to automatically determine the quantity and in some cases cost difference for a new change order, to keep track of various change orders and their status, and to quickly determine conflicts between various change orders.

As would be known to a person of ordinary skill in the art, the software program of the preferred embodiment of the present invention is generally stored in memory in a computer device and is run by a processor inside that computer. This processor can be located in a computer in an office, in a local or remote server, or in a network cloud.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A method for tracking change orders in a construction project comprising:
accessing a bid for the construction project, the bid including at least one construction drawing and at least one building condition required to complete the at least one construction drawing, wherein the construction drawing comprises one or more objects and the building condition has an original quantity associated with it;
accessing a first change order bid for the project, the first change order bid including at least one first change order construction drawing and at least one first change order building condition, the first change order construction drawing comprising a copy of the construction drawing and the first change order building condition being a copy of the building condition, wherein the first change order building condition is displayed with a first change order quantity of zero;
receiving a change to the first change order construction drawing;
calculating a change in the associated quantity of the building condition based on the change in the first change order construction drawing; and
changing the displayed first change order quantity from zero to the calculated change.

2. The method of claim 1, further comprising calculating a change in a cost of the construction project based on the calculated change.

3. The method of claim 1, wherein the change to the first change order construction drawing comprises making a change to at least one of the one or more objects.

4. The method of claim 1, wherein the change to the first change order construction drawing comprises adding a new object

5. The method of claim 1, wherein the change to the first change order construction drawing comprises adding a new building condition and at least one new object associated with the new building condition.

6. The method of claim 1, wherein the change to the first change order construction drawing comprises deleting the first object.

7. The method of claim 1, wherein the first change order construction drawing displays the one or more objects in a first color and further comprising displaying the change in the first change order construction drawing in a second color.

8. The method of claim 7, further comprising, accessing a second change order bid for the project, the second change order bid comprising at least one second change order construction drawing and at least one second change order building condition, the second change order construction drawing being a copy of the first change order construction drawing and the second change order building condition being a copy of the first change order building condition, wherein the second change order construction drawing displays the change in the first change order construction drawing in a third color and displays all other objects in the first color, and the second change order building condition is displayed with a second change order quantity of zero;
receiving a change to the second change order construction drawing;
displaying the change to the second change order construction drawing in a fourth color; and
calculating a second change in the associated quantity of the second building condition based on the change to the second change order construction drawing; and
changing the displayed second change order quantity for the second change order building condition from zero to the second change.

9. The method of claim 8, further comprising receiving an indication that the first change order bid has been accepted.

10. The method of claim 9, further comprising displaying the change to the first change order construction drawing in the first color in the second change order construction drawing.

11. A machine-readable storage medium comprising software that causes a processor to:
access a bid for the construction project; the bid including at least one construction drawing having at least one building condition required to complete the at least one construction drawing, and one or more objects, wherein the at least one building condition has an original quantity associated with it;
access a first change order bid for the project, the first change order bid including at least one first change order construction drawing that is a copy of the at least one construction drawing, wherein the first change order construction drawing displays the one or more objects in a first color and the building condition is displayed with a first change order quantity of zero;
receive a change to the first change order construction drawing;
display the change to the first change order construction drawing in a second color; and
calculate a change in the associated quantity of the building condition based on the change to the first change order construction drawing; and
change the displayed first change order quantity from zero to the calculated change in the associated quantity.

12. The machine-readable storage medium of claim 11, wherein the processor further calculates a change in a cost of the construction project based on the calculated change.

13. The machine-readable storage medium of claim 11, wherein the software further causes the processor to:
access a second change order bid for the project, the second change order bid including at least one second change order construction drawing that is a copy of the first change order construction drawing, wherein the second change order construction drawing displays the change to the first change order construction drawing in a third color and displays all other objects in the first color, and the building condition is displayed with a second change order quantity of zero;
receive a change to the second change order construction drawing;
display the change to the second change order construction drawing in a fourth color; and
calculate a change in the associated quantity of the second building condition based on the change to the second change order construction drawing; and
change the displayed second change order quantity for the second change order building condition from zero to the calculated change.

14. The machine-readable storage medium of claim 13, wherein the processor further receives an indication that the first change order has been accepted.

15. The machine-readable storage medium of claim 14, wherein the processor further displays the change to the first change order construction drawing in the first color in the second change order construction drawing.

16. The machine-readable storage medium of claim 15, wherein the processor further displays the change to the first change order construction drawing in the bid.

17. A method for tracking change orders in a construction project comprising:
accessing a bid for the construction project; the bid including at least one construction drawing having at least one building condition comprising one or more objects; wherein the at least one building condition has an original quantity associated with it;
creating a first change order bid, the first change order bid including at least a first change order construction drawing that is a copy of the at least one construction drawing, wherein the building condition is displayed in the first change order bid with a first change order quantity of zero;
receiving a change to the first change order construction drawing;
displaying the change in the first change order construction drawing; and
calculating a total quantity associated with the building condition in the first change order drawing based on the change in the first change order construction drawing and the original quantity;
calculating a difference between the total quantity and the original quantity; and
displaying the calculated difference as a quantity associated with the building condition in the first change order drawing.

18. The method of claim 17, further comprising calculating a change in a cost of the construction project based on the calculated difference.

19. The method of claim 17, wherein the change to the first change order construction drawing comprises a change to at least one of the one or more objects.

20. The method of claim 17, wherein the change to the first change order construction drawing comprises adding a new object

21. The method of claim 17, wherein the change to the first change order construction drawing comprises adding a new building condition and at least one new object associated with the new building condition.

22. The method of claim 17, wherein the change to the first change order construction drawing comprises deleting the first object.

23. The method of claim 17, further comprising, accessing a second change order bid for the project, the second change order bid including at least one second change order construction drawing that is a copy of the first change order construction drawing, wherein the building condition is displayed with a second change order quantity of zero;
receiving a change to the second change order construction drawing; and
calculating a second change in the associated quantity of the building condition in the second change order construction drawing based on the change to the second change order construction drawing; and
changing the displayed second change order quantity from zero to the second change.

24. The method of claim 23, further comprising receiving an indication that the first change order bid has been accepted.

25. The method of claim 24, displaying the change in the first change order construction drawing in the bid.
